(19) United States
(12) Patent Application Publication
(10) Pub. No.: US 2013/0310490 A1
(43) Pub. Date: Nov. 21, 2013

(54) ENVIRONMENTALLY FRIENDLY HEAT-SHRINKABLE FILM

(71) Applicants: Deuk-Young Lee, Suwon-si (KR); Sang Il Kim, Suwon-si (KR)

(72) Inventors: Deuk-Young Lee, Suwon-si (KR); Sang Il Kim, Suwon-si (KR)

(73) Assignee: SKC CO., LTD, Gyeonggi-do (KR)

(21) Appl. No.: 13/885,910

(22) PCT Filed: Nov. 21, 2011
(86) PCT No.: PCT/KR2011/008878

§ 371 Date: Aug. 2, 2013

(30) Foreign Application Priority Data
Nov. 19, 2010 (KR) 10-2010-0115424

(51) Int. Cl. C08G 64/02

(52) U.S. Cl. CPC C08G 64/0208
USPC 524/35; 528/405; 428/220; 525/450; 525/418; 524/391; 525/439

(57) ABSTRACT

A heat-shrinkable film comprising an aliphatic polycarbonate, wherein the film is uniaxially or biaxially oriented, and exhibits a heat-shrinkage of at least 30% in at least one direction when treated with hot air at 70° C. for 10 min, has an improved transparency and good heat-shrinkability which can be used for various purposes such as a label or wrapping material.

### FIELD OF THE INVENTION

The present invention relates to an environmentally friendly heat-shrinkable film having an improved degradability which is useful as a label or wrapping material.

### BACKGROUND OF THE INVENTION

Heat-shrinkable films have been extensively used, e.g., for labeling bottles, batteries or electrolytic condensers, and for wrapping containers and other products. However, conventional heat-shrinkable films such as polyethylene (PE) and polypropylene (PP), polyvinyl chloride (PVC), polystyrene (PS), polyester (PET) films are not completely satisfactory in terms of their performance characteristics. These petroleum-derived films require high energy-consumption, emit a large amount of carbon dioxide, and generate environmentally hazardous pollutants when disposed or incinerated.

Although recycling levels of plastics increase in recent years, the recycling ratio of plastics are still in the range of 30-40% of the total plastic wastes, and most of plastic wastes are disposed by landfill or incineration. Incineration has advantages in that it can save landfill area and the heat generated therefrom can be used as an energy resource.

However, incineration of plastics has the problem that it generates environmentally hazardous pollutants. For example, PVC films have recently become disfavored because they emit toxic pollutants such as dioxin on combustion due to their components of chlorine, plasticizer and other additives. Further, PP, PS, and PET films are chemically and biologically very stable so that they are not biodegradable and they accumulate in the soil when disposed, which shortens landfill life and causes soil pollution.

In order to solve such problems, there have been employed environmentally friendly polymers such as biodegradable polylactic acid (PLA). Korean Patent No. 10-0762546 discloses a polylactic acid-based film comprising polyester copolymers. However, the conventional films use aromatic compounds so that they still have the problem of pollutants when disposed.

Therefore, there is a need for developing a novel heat-shrinkable film which can solve the problems of conventional heat-shrinkable films.

### SUMMARY OF THE INVENTION

Accordingly, it is an object of the present invention to provide an environmentally friendly heat-shrinkable film having an improved degradability and heat-shrinkability which is useful as a label or wrapping material.

In accordance with an aspect of the present invention, there is provided an environmentally friendly heat-shrinkable film comprising an aliphatic polycarbonate, wherein the film is uniaxially or biaxially oriented, and exhibits a heat-shrinkage of at least 30% in at least one direction when treated with hot air at 70° C. for 10 min.

Further, the present invention provides wrapping material or a label comprising the heat-shrinkable film.

The heat-shrinkable aliphatic polycarbonate film of the present invention has an improved transparency and good heat-shrinkability which can be used for various purposes such as a heat-shrinkable label or wrapping material. Further, since the inventive film is prepared by using carbon dioxide, the film is environmentally friendly and hardly emits pollutants when disposed or incinerated.

### DETAILED DESCRIPTION OF THE INVENTION

The heat-shrinkable film of the present invention is characterized in that the film comprises an aliphatic polycarbonate, wherein the film is uniaxially or biaxially oriented and exhibits a heat-shrinkage of at least 30% in at least one direction when treated with hot air at 70° C. for 10 min.

The aliphatic polycarbonate of the first polymer may be prepared by copolymerization of carbon dioxide and an epoxide compound, the epoxide compound being selected from the group consisting of an alkylene oxide, a cycloalkene oxide and a mixture thereof. The copolymerization is preferably alternating copolymerization. Examples of catalysts for copolymerization include Zn precursors such as diethyl zinc (U.S. Pat. No. 3,585,168), coordination complexes containing onium salts (Korean Patent No. 10-0853358), and cobalt catalysts.

Examples of the epoxide compound include ethylene oxide, propylene oxide, butene oxide, pentene oxide, hexene oxide, octene oxide, decene oxide, dodecene oxide, tetradecene oxide, hexadecene oxide, octadecene oxide, butadiene monooxide, 1,2-epoxide-7-octene, cyclopentene oxide, cyclohexene oxide, cyclooctene oxide, cyclododecene oxide, 2,3-epoxide norbornene, limonene oxide, and a mixture thereof.

The copolymerization process may be conducted under CO₂ pressure of 1 to 100 atm, preferably 5 to 30 atm. Further, the copolymerization may proceed at a temperature of 20° C. to 120° C., preferably 50° C. to 90° C.

The copolymerization process may be conducted through a batch or semibatch process, or a continuous process. In case of batch or semibatch process, the reaction time for copolymerization may be 1 to 24 hours, preferably 1.5 to 4 hours. In case of continuous process, the average retention time of catalysts is preferably 1.5 to 4 hours.

The examples of the aliphatic polycarbonate include polyethylene carbonate, polypropylene carbonate, and a polymer blend thereof.

The aliphatic polycarbonate used in the inventive film preferably has a number-average molecular weight (Mn) ranging from 50,000 to 1,000,000, wherein the Mn is measured by gel-permeation chromatography (GPC) using polystyrene having a uniform distribution of molecular weight as a standard material for calibration.

Aromatic polycarbonates are very dangerous even in the preparation process because toxic bisphenol-A and phosgene are used as starting materials. In contrast, aliphatic polycarbonates prepared by using carbon dioxide are very safe and they can contribute to reduction of carbon dioxide emission. Further, aromatic polycarbonates are hardly decomposed in soil when disposed and they generate toxic pollutants when incinerated, whereas aliphatic polycarbonates can be degraded into carbon dioxide and water by incineration.

The heat-shrinkable film of the present invention can be prepared by the steps comprising melt-extruding an aliphatic polycarbonate resin at 140 to 240° C. to obtain a sheet and then drawing the sheet.

In the preparation, the sheet may be drawn in both the longitudinal and the transverse directions to obtain a biaxially oriented film or may be drawn in one of the longitudinal and the transverse directions to obtain a uniaxially oriented film.

Preferably, the draw ratio in at least one of the longitudinal and the transverse directions is 3 to 10, and the drawing temperature is higher than the glass transition temperature (Tg) of the resin and lower than the melting temperature (m.p.) of the resin. When the draw ratio and temperature fall within the above ranges, the heat-shrinkability of the film can be more improved.

The aliphatic polycarbonate resin may further comprise other additives such as electrostatic generator, anti-static agent, anti-oxidant, heat stabilizer, compatibilizer, UV blocking agent, anti-blocking agent and inorganic lubricant to the extent they do not adversely affect the film properties.

Further, the feedstock resin of the inventive film may further comprise a second polymer which is different from the aliphatic polycarbonate by blending or compounding to the extent they do not adversely affect the film properties.

Examples of the second polymer is selected from the group consisting of polylactic acid, polylactic acid copolymers, polycaprolactone, polyhydroxyalkanoates, polyglycolic acid, polybutylene succinate, polybutylene adipate, poly(butylene adipate-co-succinate), cellulose-based polymers, polyhydroxyalkylates, poly(butylene adipate-co-terephthalate), poly(butylene succinate-co-terephthalate), and a polymer blend thereof.

Further, the method for preparing the inventive film may further comprise coating with inorganic particles on one or both sides of the film in order to give a blocking resistance and anti-static property to the film. Further, the method may further comprise a corona-treatment to improve the processability of the film. Further, the method may further comprise a coating process to improve the printability of the film.

The inventive film exhibits a heat-shrinkage of at least 30% in at least one direction when treated with hot air at 70° C. for 10 min. When the heat-shrinkage ratio falls within the above range, the film can be applied for various shapes of containers or other purposes.

Further, the inventive film may have a thickness of 30 to 100 μm in order to improve processability and uniform shrinkage.

Further, the inventive film preferably exhibits a haze of 10% or less, more preferably 5% or less, which is advantageous for various wrapping uses.

Accordingly, the inventive film can be used a label or wrapping material.

As stated above, the heat-shrinkable aliphatic polycarbonate film of the present invention has an improved transparency and good heat-shrinkability which can be used for various purposes such as a heat-shrinkable label or wrapping material. Further, since the inventive film is prepared by using carbon dioxide, the film is environmentally friendly and hardly emits pollutants when disposed or incinerated.

Hereinafter, the present invention is described more specifically by the following examples but these are provided only for illustrations and the present invention is not limited thereto.

The compositions and processes for preparing films according to the present invention and conventional process are summarized in Table 1.

### Example 1

### Preparation of Aliphatic PC Film (1)

A polypropylene carbonate resin (QPAC40, Empower Materials Inc.) which is prepared by alternating copolymerization of carbon dioxide and propylene oxide, was dried at 40° C. for 3 hours.

The dried resin was melt-extruded at 160° C. The extrudate was drawn 3 times in the longitudinal direction at 85° C. and then drawn 4 times in the transverse direction at 85° C., followed by cooling at room temperature to obtain an aliphatic PC film having a thickness of 40 μum.

### Example 2

### Preparation of Aliphatic PC Film (2)

A polyethylene carbonate resin (QPAC25, Empower Materials Inc.) which is prepared by alternating copolymerization of carbon dioxide and ethylene oxide, was dried at 40° C. for 3 hours.

The dried resin was melt-extruded at 140° C. The extrudate was drawn 3 times in the longitudinal direction at 85° C. and then drawn 4 times in the transverse direction at 85° C., followed by cooling at room temperature to obtain an aliphatic PC film having a thickness of 40 μm.

### Example 3

### Preparation of Aliphatic PC Film (3)

(a) Preparation of Polycarbonate

10.0 g (172 mmol) of propylene oxide was placed in a bomb reactor, and a coordination complex containing onium salt (Co(salen) complex) was added thereto in an amount of 40 ppm (salen: N,N′-bis(salicylidene)ethylenediamine and bis(triphenylphosphine)iminium chloride).

The bomb reactor was put in an oil bath and maintained at 50° C. for 15 min with stirring to balance the temperature. The reaction pressure was raised to 20 bar by using CO₂ gas and the reaction proceeded until the pressure in the reactor falls down to about 3 bar to obtain a viscous liquid.

The viscous liquid was added dropwise to methanol and then a white solid was isolate. The solid was added to methanol and stirred for 12 hours to obtain a solid product. The solid product was dried under reduced pressure to obtain polypropylene carbonate.

(b) Preparation of PC Film

The polypropylene carbonate obtained in step (a) was melt-extruded at 190° C. The extrudate was drawn 4 times in the transverse direction at 85° C., followed by cooling at room temperature to obtain an aliphatic PC film having a thickness of 40 μm.

### Example 4

### Preparation of Aliphatic PC Film (4)

Polypropylene carbonate was prepared by the procedure of step (a) of Example 3, except that the temperature of the oil bath was set to 90° C. in order to increase the molecular weight of the polymer.

The resulting polypropylene carbonate was melt-extruded at 190° C. The extrudate was drawn 4 times in the longitudinal direction at 85° C., followed by cooling at room temperature to obtain an aliphatic PC film having a thickness of 40 μm.

### Comparative Example 1

### Preparation of PVC Shrinkable Film

A polyvinyl chloride resin (TK-800, Shin-Etsu Chemical Co., Ltd.) was mixed with dioctyl phthalate (Shin-Nihon Chemical Co., Ltd.) at a weight ratio of 90:10.

The resulting resin was melt-extruded at 160° C. The extrudate was drawn 2 times in the longitudinal direction at 90° C. and then drawn 3 times in the transverse direction at 90° C., followed by cooling at room temperature to obtain an aliphatic PVC film having a thickness of 40 μm.

### Comparative Example 2

### Preparation of Polyolefin-Based Shrinkable Film

A polypropylene resin (PP WINTEC WFX6, Nihon polypropylene Inc.) was blended with a polyethylene resin (LLDPE Kernel KF271, Nihon polyethylene Inc.) at a weight ratio of 50:50.

The polymer blend was melt-extruded at 200° C. and then cooled by a casting roll at 30° C. to obtain a sheet having a thickness of 200 μm.

The sheet was preheated at 80° C. using a tenter and then drawn 5 times in the longitudinal direction at 75° C., followed by cooling at room temperature to obtain a polyolefin-based film having a thickness of 40 μm.

### Comparative Example 3

### Preparation of Polystyrene-Based Shrinkable Film

A polystyrene resin (TS-10, Dainippon Ink and Chemicals Inc.) was blended with a styrene-butadiene block copolymer resin (LG 604, LG Chem. Co., Ltd.) at a weight ratio of 80:20.

The polymer blend was melt-extruded at 220° C. and then cooled by a casting roll at 30° C. to obtain a sheet having a thickness of 200 μm.

The sheet was drawn 4 times in the transverse direction at 105° C., followed by cooling at room temperature to obtain a polyolefin-based film having a thickness of 40 μm.

### Comparative Example 4

### Preparation of Polyester-Based Shrinkable Film

(a) Preparation of Polymer A

100 parts by mole of dimethyl terephthalate and 180 parts by mole of ethylene glycol were placed in an autoclave equipped with a distillation column, and manganese acetate as an interesterification catalyst was added thereto in an amount of 0.05% by weight based on the weight of dimethyl terephthalate. While removing methanol formed during the reaction, the temperature was raised to 220° C. for 120 min.

After the interesterification was complete, trimethyl phosphate as a stabilizer was added in an amount of 0.045% by weight based on the weight of the dimethyl terephthalate. After 10 minutes, antimony trioxide as polymerization catalysts was added in amounts of 0.03% by weight based on the weight of dimethyl terephthalate.

After 5 minutes, the resulting mixture was transferred to a second reactor equipped with a vacuum unit and then allowed to polymerize at 280° C. for 140 minutes, to obtain polyethylene terephthalate (polymer A) having an intrinsic viscosity of 0.62 dL/g.

(b) Preparation of Polymer B

The procedure of step (a) was repeated, except that trimethylene glycol was used instead of ethylene glycol, to obtain polytrimethylene terephthalate (polymer B) having an intrinsic viscosity of 0.85 dL/g.

(c) Preparation of Polymer C

The procedure of step (a) was repeated, except that 90 parts by mole of ethylene glycol and 90 parts by mole of 2,2-dimethyl-(1,3-propane)diol were used instead of 180 parts by mole of ethylene glycol, to obtain a polyester copolymer (polymer C) having an intrinsic viscosity of 0.64 dL/g.

(d) Preparation of Polyester-Based Shrinkable Film

Polymers A, B and C were dried under reduced pressure to reduce water content thereof to 0.05 wt % or less. The dried polymers A, B and C were blended at a ratio of 40:25:35.

The polymer blend was melt-extruded at 280° C. and then cooled by a casting roll at 30° C. to obtain a sheet.

The sheet was drawn 3 times in the longitudinal direction and then drawn 4 times in the transverse direction to obtain a biaxially oriented shrinkable film having a thickness of 40 μm.

The films obtained in Examples 1 and 4 and Comparative Examples 1 to 4 were evaluated for the following properties. The results are shown in Table 1.

### (1) Molecular Weight

0.003 g of a resin sample was dissolved in tetrahydrofuran (THF) and the resulting solution was injected into a GPC with ELSD (Waters Ltd., USA) at room temperature, and the eluent rate was 1 mL/min.

### (2) Heat-Shrinkage

A film sample was cut into 200 mm (length)×15 mm (width) pieces, maintained at 70° C. in a hot air oven for 10 min, and the length of the pieces were measured. Using the following equation, the degrees of shrinkage in each of the longitudinal and the transverse directions were calculated:

Heat shrinkage (%)=[(length before heat treatment−length after heat treatment)/length before heat treatment]×100

### (3) Haze

The haze of a film sample was measured according to ASTM D1003 by using a hazemeter (SEP-H, Nihon Semitsu Kogaku Co., Ltd.).

### (4) Volatile Organic Compound (VOC)

10 g of a film sample was placed in a pot and introduced in an electric furnace (HY-80005), to which compressed air was flew at a rate of 60 mL/min with raising the temperature to 600° C. At the temperature condition, the exhausted gas was collected for 1 hours by using Tedlar bag. The exhaust gas was filtered before the collection to remove scattering impurity particles therefrom. The collected gas passed through a low temperature evaporator and then transferred to a gas separator. The gas was analyzed qualitatively and quantitatively using gas chromatography (carrier: He gas, 5973 inert, Agilent Technology Inc.) to obtain the contents of volatile organic compounds.

TABLE 1

| | | | | Example | | | | Comparative Example | | | |
|---|---|---|---|---|---|---|---|---|---|---|---|
| Items | | | unit | 1 | 2 | 3 | 4 | 1 | 2 | 3 | 4 |
| Compo- | resin | type | — | PPC | PEC | PPC | PPC | PVC | PP + PE | PS | PET |
| sition | | MW | Dalton | 130,000 | 102,000 | 98,000 | 145,000 | — | — | — | — |
| Process | draw ratio | L.D. | times | 3 | 3 | 1 | 4 | 2 | 5 | 1 | 3 |
| | | T.D. | times | 4 | 4 | 4 | 1 | 3 | 1 | 4 | 4 |
| Property | heat- | L.D. | % | 43 | 50 | 2 | 36 | 18 | 12 | 2 | 20 |
| | shrinkage | T.D. | % | 52 | 65 | 48 | 4 | 22 | 1 | 35 | 30 |
| | haze | | % | 4 | 3 | 2 | 2 | 8 | 4 | 10 | 5 |
| VOC | hetero- | furan | ppb | <1 | <1 | <1 | <1 | <1 | <1 | 80 | 41 |
| | aromatics | 2-methylfuran | ppb | <1 | <1 | <1 | <1 | 24 | 117 | 28 | 28 |
| | aliphatic | 1-butene | ppb | <1 | <1 | <1 | <1 | <1 | 188 | 31 | 107 |
| | alkenes | 1-hexene | ppb | <1 | <1 | <1 | <1 | 111 | 995 | 358 | 55 |
| | aliphatic | cyclohexane | ppb | <1 | <1 | <1 | <1 | <1 | 11 | 23 | 136 |
| | alkanes | hexane | ppb | <1 | <1 | <1 | <1 | 16 | 39 | 17 | 6 |
| | aromatic | benzene | ppb | 0 | 0 | 0 | 0 | 545 | 672 | 2795 | 762 |
| | compounds | toluene | ppb | 0 | 0 | 0 | 0 | 100 | 46 | 203 | 380 |
| | chlorine-based | chloroform | ppb | 0 | 0 | 0 | 0 | 2 | 3 | 0 | 0 |
| | compounds | dichloromethane | ppb | 0 | 0 | 0 | 0 | 7 | 0 | 3 | 58 |

L.D.: Longitudinal direction
T.D.: Transverse direction

As shown in Table 1, the inventive films obtained in Examples 1 and 4 exhibited a higher heat-shrinkage and transparency than the conventional films obtained in Comparative Examples 1 to 4.

Further, the inventive films did not generate environmentally hazardous pollutants such as volatile organic compounds.

While the invention has been described with respect to the above specific embodiments, it should be recognized that various modifications and changes may be made to the invention by those skilled in the art which also fall within the scope of the invention as defined by the appended claims.

1. A heat-shrinkable film comprising an aliphatic polycarbonate, wherein the film is uniaxially or biaxially oriented and exhibits a heat-shrinkage of at least 30% in at least one direction when treated with hot air at 70° C. for 10 min.

2. The heat-shrinkable film of claim 1, wherein the aliphatic polycarbonate is prepared by copolymerization of carbon dioxide and an epoxide compound, the epoxide compound being selected from the group consisting of an alkylene oxide, a cycloalkene oxide, and a mixture thereof.

3. The heat-shrinkable film of claim 2, wherein the aliphatic polycarbonate is selected from the group consisting of polyethylene carbonate, polypropylene carbonate, and a polymer blend thereof.

4. The heat-shrinkable film of claim 1, wherein the aliphatic polycarbonate has a number-average molecular weight (Mn) ranging from 50,000 to 1,000,000.

5. The heat-shrinkable film of claim 1, wherein the film further comprises a second polymer different from the aliphatic polycarbonate by way of blending or compounding.

6. The heat-shrinkable film of claim 5, wherein the second polymer is selected from the group consisting of polylactic acid, polylactic acid copolymers, polycaprolactone, polyhydroxyalkanoates, polyglycolic acid, polybutylene succinate, polybutylene adipate, poly(butylene adipate-co-succinate), cellulose-based polymers, polyhydroxyalkylates, poly(butylene adipate-co-terephthalate), poly(butylene succinate-co-terephthalate), and a polymer blend thereof.

7. The heat-shrinkable film of claim 1, wherein the film is drawn 3 to 10 times in at least one direction of the longitudinal and the transverse directions.

8. The heat-shrinkable film of claim 1, wherein the film has a haze of 10% or less.

9. The heat-shrinkable film of claim 1, wherein the film has a thickness of 30 to 100 μm.

10. A wrapping material comprising the heat-shrinkable film according to claim 1.

11. A label comprising the heat-shrinkable film according to claim 1.
